(19) United States
(12) Patent Application Publication
(10) Pub. No.: US 2013/0221940 A1
(43) Pub. Date: Aug. 29, 2013

(54) LINEAR REGULATOR

(71) Applicants: Shouli Yan, Austin, TX (US); Dazhi Wei, Austin, TX (US); Alan L. Westwick, Austin, TX (US)

(72) Inventors: Shouli Yan, Austin, TX (US); Dazhi Wei, Austin, TX (US); Alan L. Westwick, Austin, TX (US)

(21) Appl. No.: 13/404,558

(22) Filed: Feb. 24, 2012

(51) Int. Cl. G05F 1/10

(52) U.S. Cl. 323/273

(57) ABSTRACT

A technique includes using a pass device of a linear regulator to provide an output signal for the linear regulator in response to a signal that is received at a control terminal of the pass device. The control terminal is coupled to a node, and the node is associated with a bias current. The technique includes using a feedback path to communicate a feedback current with the node to regulate the output signal. The use of the feedback path includes regulating a magnitude of the feedback current to be within a range of magnitudes, which include a magnitude that exceeds a magnitude of the bias current.

### BACKGROUND

Electronic systems typically employ voltage regulators for purposes of generating supply voltages for the various components of the system. One type of voltage regulator is a DC-to-DC switching converter, which typically regulates its output voltage by selectively activating and deactivating switches to energize and de-energize one or more energy storage components of the switching regulator. Another type of voltage regulator is a linear regulator, which typically regulates its output voltage by controlling a difference between the output voltage and the regulator's input voltage. More specifically, a typical linear regulator includes a differential amplifier that controls a voltage drop across a pass transistor of the regulator for purposes of regulating the output voltage.

### SUMMARY

In an exemplary embodiment, a technique includes using a pass device of a linear regulator to provide an output signal for the linear regulator in response to a signal that is received at a control terminal of the pass device. The control terminal is coupled to a node, and the node is associated with a bias current. The technique includes using a feedback path to communicate a feedback current with the node to regulate the output signal. The use of the feedback path includes regulating a magnitude of the feedback current to be within a range of magnitudes, which includes a magnitude that exceeds a magnitude of the bias current.

In another exemplary embodiment, a regulator includes a pass device and a feedback path. The pass device includes a control terminal and is adapted to provide an output signal for the regulator in response to a signal that is received at the control terminal. The control terminal is coupled to a node, and the node is associated with a bias current. The feedback path communicates a feedback current with the node to regulate the output signal. The feedback path is adapted to regulate a magnitude of the feedback current within a range of magnitudes, which includes a magnitude that exceeds a magnitude of the bias current.

In yet another exemplary embodiment, an apparatus includes an integrated circuit that includes a regulator, which includes an amplifier, a pass device, a first feedback path and a second feedback path. An output terminal of the amplifier is coupled to a control terminal of the pass device. The pass device includes an output terminal that provides an output signal for the regulator in response to a signal that is received at the control terminal of the pass device. The amplifier is adapted to regulate the signal received at the control terminal of the pass device in response to a signal that is provided by the first feedback path. The second feedback path is adapted to communicate a feedback current between the output terminal of the pass device and the output terminal of the amplifier to regulate the output signal.

Advantages and other desired features will become apparent from the following drawing, description and claims.

### BRIEF DESCRIPTION OF THE DRAWING

FIG. 1 is a schematic diagram of a transceiver system according to an exemplary embodiment.

FIG. 2 is a schematic diagram of a microcontroller unit of the system of FIG. 1 according to an exemplary embodiment.

FIG. 3 is a block diagram of a linear regulator of the microcontroller unit of FIG. 2 according to an exemplary embodiment.

FIG. 4 is a flow diagram depicting a technique to regulate a linear regulator according to an exemplary embodiment.

FIG. 5 is a more detailed schematic diagram of the linear regulator of FIG. 3 according to an exemplary embodiment.

FIG. 6 is a schematic diagram of a charge path used by the linear regulator of FIG. 5 according to an exemplary embodiment.

FIG. 7 is a schematic diagram of a discharge path used by the linear regulator of FIG. 5 according to an exemplary embodiment.

### DETAILED DESCRIPTION

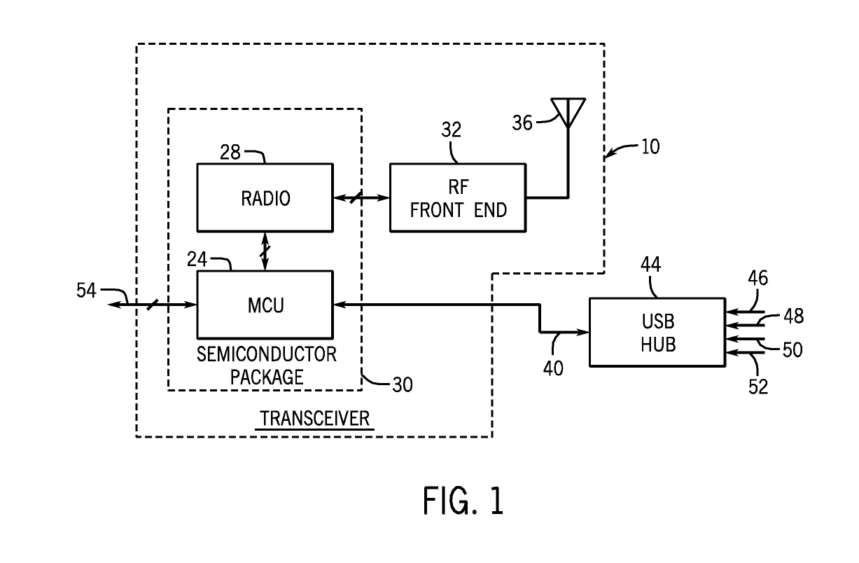

Referring to FIG. 1, in accordance with embodiments disclosed herein, an embedded microcontroller unit (MCU) 24 (or microprocessor, controller, etc.) may be used in a variety of applications, such as applications in which the MCU 24 controls various aspects of a transceiver 10 (as a non-limiting example). In this regard, the MCU 24, for this particular example, may be part of an integrated circuit (IC), or semiconductor package 30, which also includes a radio 28. As a non-limiting example, the MCU 24 and the radio 28 may collectively form a packet radio, which processes incoming and outgoing streams of packet data. To this end, the transceiver 10 may further include a radio frequency (RF) front end 32 and an antenna 36, which receives and transmits RF signals (frequency modulated (FM) signals, for example) that are modulated with the packet data.

As non-limiting examples, the transceiver 10 may be used in a variety of applications that involve communicating packet stream data over relatively low power RF links and as such, may be used in wireless point of sale devices, imaging devices, computer peripherals, cellular telephone devices, etc. As a specific non-limiting example, the transceiver 10 may be employed in a smart power meter which, through a low power RF link, communicates data indicative of power consumed by a particular load (a residential load, for example) to a network that is connected to a utility. In this manner, the transceiver 10 may transmit packet data indicative of power consumed by the load to mobile meter readers as well as to an RF-to-cellular bridge, for example. Besides transmitting data, the transceiver 10 may also receive data from the utility or meter reader for such purposes (as non-limiting examples) as inquiring as to the status of various power consuming devices or equipment; controlling functions of the smart power meter; communicating a message to a person associated with the monitored load, etc.

As depicted in FIG. 1, in addition to communicating with the radio 28, the MCU 24 may further communicate with other devices and in this regard may, as examples, communicate over communication lines 54 with a current monitoring and/or voltage monitoring device of a smart power meter (as a non-limiting example) as well as communicate with devices over a serial bus 40. In this manner, the serial bus 40 may include data lines that communicate clocked data signals, and the data may be communicated over the serial bus 40 data in non-uniform bursts. As a non-limiting example, the serial bus may be a Universal Serial Bus (USB) 40, as depicted in FIG. 1, in accordance with some embodiments. As described herein, in addition to containing lines to communicate data, the serial bus, such as the USB 40, may further include a power line (a 5 volt power line, for example) for purposes of providing power to serial bus devices, such as the MCU 24. Various USB links 46, 48, 50 and 52 may communicate via a hub 44 and USB 40 with the transceiver 10 for such purposes as communicating with a residential computer regarding power usage of various appliances, communicating with these appliances to determine their power usages, communicating with the appliances to regulate their power usages, etc.

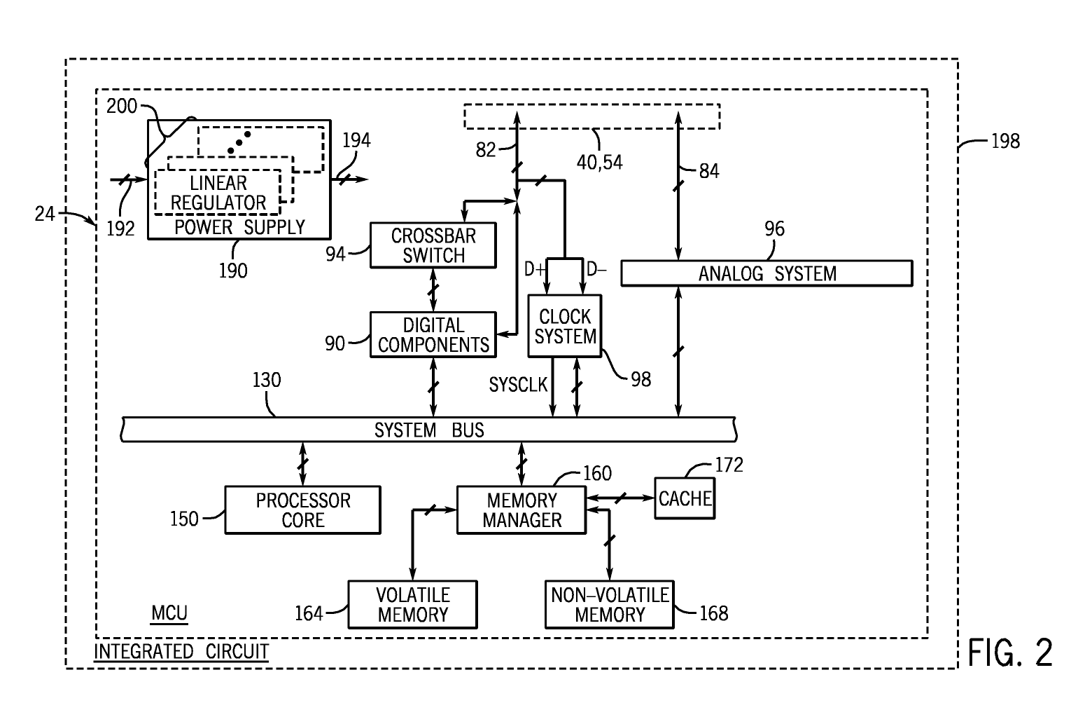

Referring to FIG. 2, in general, depending on the particular embodiment, some or all of the components of the MCU 24 may be part of an integrated circuit 198. In some embodiments, some or all of the components of the MCU 24 may be fabricated on a single die of the integrated circuit 198; and in other embodiments, the components of the MCU 24 may be fabricated on more than one die of the integrated circuit 198. Thus, many variations are contemplated, which are within the scope of the appended claims.

Among its components, the MCU 24 includes a processor core 150. As a non-limiting example, the processor core 150 may be a 32-bit core, such as the Advanced RISC Machine (ARM) processor core, which executes a Reduced Instruction Set Computer (RISC) instruction set. In general, the processor core 150 communicates with various other system components of the MCU 24, such as a memory controller, or manager 160, over a system bus 130. In general, the memory manager 160 controls access to various memory components of the MCU 24, such as a cache 172, a non-volatile memory 168 (a Flash memory, for example) and a volatile memory 164 (a static random access memory (SRAM), for example).

For purposes of producing clock signals for use by the components of the MCU 24, such as the processor core 150, the MCU 24 includes a clock system 98. As depicted in FIG. 2, for purposes of an example, the clock system 98 is depicted as providing a system clock signal called “SYSCLK” in FIG. 2 to the system bus 130. In general, the clock system 98 recovers a clock signal used in the communication of bursty data on data lines (labeled as the “D+” and “D-” in FIG. 2) over the USB 40 and may use this recovered clock signal as the system clock signal.

The MCU 24 includes various digital peripheral components 90, such as (as non-limiting examples) a Universal Serial Bus (USB) interface, a programmable counter/timer array (PCA), a universal asynchronous receiver/transmitter (UART), a system management bus (SMB) interface, a serial peripheral interface (SPI), etc. The MCU unit 24 may include a crossbar switch 94, which permits the programmable assigning of the digital peripheral components 90 to digital output terminals 82 of the MCU 24. In this regard, the MCU 24 may be selectively configured to selectively assign certain output terminals 82 to the digital peripheral components 90.

In accordance with some embodiments, the MCU 24 includes an analog system 96, which communicates analog signals on external analog terminals 84 of the MCU 24 and generally forms the MCU's analog interface. As an example, the analog system 96 may include various components that receive analog signals, such as analog-to-digital converters (ADCs), comparators, etc.; and the analog system 96 may include components (supply regulators) that furnish analog signals (power supply voltages, for example) to the terminals 84, as well as components, such as current drivers.

In accordance with embodiments disclosed herein, the MCU 24 includes a power supply 190, which furnishes supply voltages to supply voltage rails 194 for purposes of providing power to the various components of the MCU 24. For this purpose, the power supply 190 may include one or more linear regulators 200 (low dropout (LDO) linear regulators, as a non-limiting example). Depending on the particular embodiment, the power supply 190 may include a DC-to-DC switching converter (a Buck switching converter, for example), which receives an input voltage (a battery voltage communicated to the power supply 190 via input terminals 192, for example) and furnishes a regulated, reduced voltage to the input terminals of the linear regulators 200.

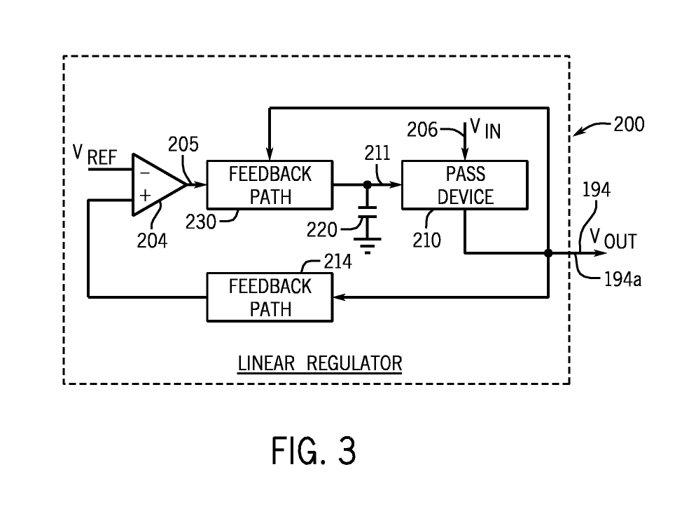

Referring to FIG. 3, in accordance with some embodiments, a given linear regulator 200 provides a regulated output voltage (called “V_{OUT},” in FIG. 3) in response to an input voltage (called “V_{IN},” in FIG. 3). In this regard, a pass device 210 of the linear regulator 200 is coupled between an input terminal 206 that receives the V_{IN} input voltage and an output terminal 194a that provides the V_{OUT} output voltage. In general, the linear regulator 200 compares the V_{OUT} output voltage to a reference voltage, and based on this comparison, the linear regulator 200 controls the voltage drop across the pass device 210 (i.e., controls the difference between the V_{IN} and V_{OUT} voltages) to regulate the V_{OUT} voltage.

More specifically, in accordance with some embodiments, the linear regulator 200 includes an error amplifier, such as a differential amplifier 204, which compares a voltage that is proportional to the V_{OUT} voltage to a reference voltage (called “V_{REF},” in FIG. 3). For this purpose, the linear regulator 200 includes a feedback path 214, which is coupled between the output terminal 194a and the non-inverting input terminal of the amplifier 204. For this example, the inverting input terminal of the amplifier 204 receives the V_{REF} reference voltage, an output terminal 205 of the amplifier 204 is coupled to the control terminal 211 of the pass device 210 and the pass device 210 varies the V_{OUT} output voltage with the signal that is received at the control terminal 211. Due to the negative feedback that is provided by the feedback path 214, in general, an increase in the magnitude of the V_{OUT} output voltage causes the amplifier 204 to decrease the magnitude of the signal at the control terminal 211 to counter the increase in the V_{OUT} output voltage; and conversely, a decrease in the magnitude of the V_{OUT} output voltage, in general, causes the amplifier 204 to increase the magnitude of the signal at the control terminal 211 to counter the decrease in the magnitude of the V_{OUT} output voltage.

The control terminal 211 may be associated with a capacitance, which is represented in FIG. 3 by a capacitor 220. As a non-limiting example, in accordance with some embodiments, the capacitor 220 represents a parasitic gate capacitance of at least one metal-oxide-semiconductor field-effect-transistor (MOSFET) of the pass device 210. In other embodiments, the capacitor 220 represents a non-parasitic capacitor of the linear regulator 200; in other embodiments, the capacitor 220 represents a combination of parasitic and non-parasitic capacitances; and so forth. Moreover, in accordance with some embodiments, the capacitor 220 may represent a parasitic capacitance that is formed, in part, from a metal line of the linear regulator 200.

Regardless of the particular capacitance or capacitances that are represented by the capacitor 220, the linear regulator 200 includes an additional feedback path 230 for purposes of enhancing the linear regulator's ability to relatively rapidly charge and discharge the capacitance(s) to allow the regulator 200 to accommodate relatively rapidly changing loads. In accordance with some embodiments, the feedback path 230 routes current to and from the output terminal 194a of the linear regulator 200 to relatively rapidly charge and discharge the capacitor 220 (as appropriate) to allow the regulator 200 to relatively quickly adapt to a changing load. This arrangement may be particularly advantageous for embodiments in which the amplifier 204 is a class A amplifier, and the amplifier's output terminal 205 is associated with a relatively small bias current that may not otherwise be capable of rapidly charging and discharging the capacitance(s).

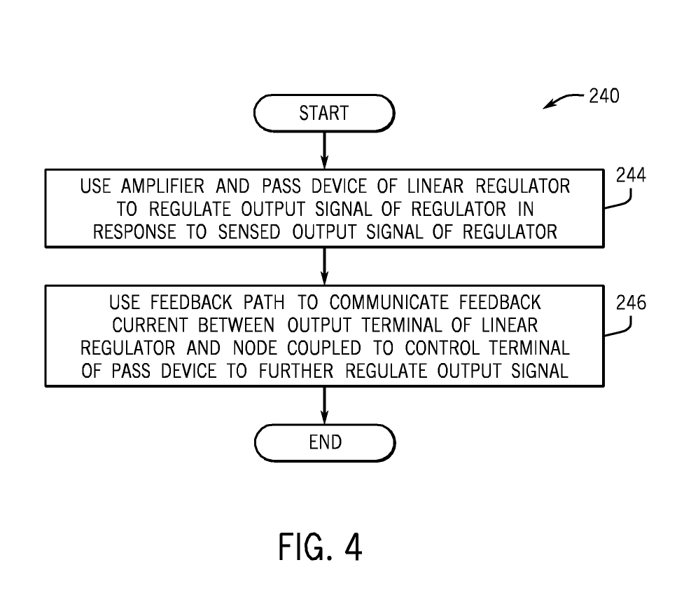

Referring to FIG. 4, thus, in accordance with some embodiments, a technique 240 includes using (block 244) an amplifier and a pass device of a linear regulator to regulate an output signal of the regulator in response to a sensed output signal of the regulator. A feedback path is used, pursuant to block 246, to communicate feedback current between an output terminal of the linear regulator and a node that is coupled to a control terminal of the pass device to further regulate the output signal.

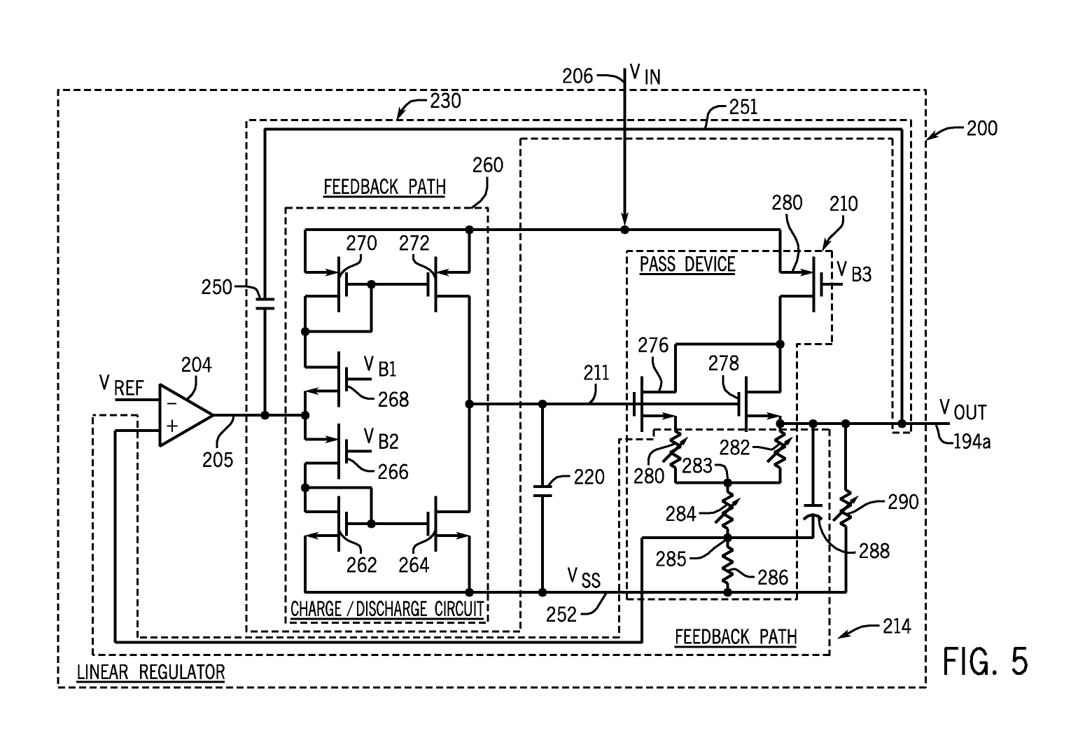

As a more specific example, FIG. 5 depicts an architecture for the linear regulator 200, in accordance with some embodiments. It is noted that other architectures may be employed, in accordance with other embodiments.

As depicted in FIG. 5, in accordance with some embodiments, the feedback path 230 includes a charge/discharge circuit 260, which is coupled between the output terminal 205 of the amplifier 204 and the control terminal 211. It is noted that in accordance with some embodiments, one or more additional amplification stages (not shown) may be coupled between the output terminal 205 and the charge/discharge circuit 260. The feedback path 230 further includes a feedback current communication line 251 that is coupled to the output terminal 194a and a feedback capacitor 250 that is coupled between the output terminal 205 of the amplifier 204 and the feedback current communication line 251.

In general, the feedback current communication line 251 communicates current away from the output terminal 194a and causes a current to be communicated from the capacitor 220 to discharge the capacitor 220 to counter a rise in the V_{OUT} output voltage; and the feedback current communication line 251 communicates current to the to the output terminal 194 and causes a current to be communicated to the capacitor 220 to charge the capacitor 220 to counter a decrease in the V_{OUT} output voltage. More specifically, discharging the capacitor 220, in general, lowers the voltage of the control terminal 211, which causes the pass device 210 to decrease the V_{OUT} output voltage; and charging the capacitor 220, in general, raises the voltage of the control terminal 211, which causes the pass device 210 to increase the V_{OUT} output voltage.

As depicted in FIG. 5, in some embodiments, the charge/discharge circuit 260 includes two biasing MOSFETs: an n-channel MOSFET 268, which has its source terminal coupled to the output terminal 205 of the amplifier 204; and a p-channel MOSFET 266, which has its source terminal coupled to the output terminal 205. The gate terminal of the MOSFET 268 receives a bias voltage (called “V_{B1}” in FIG. 5); and the gate terminal of the MOSFET 266 receives a bias voltage (called “V_{B2}” in FIG. 5). The V_{B1} and V_{B2} bias voltages may be provided by biasing network (not shown) that is coupled to the V_{IN} input voltage, for example, in accordance with some embodiments.

The drain terminal of the MOSFET 268 is coupled to the drain terminal of a p-channel MOSFET 270; and the drain terminal of the MOSFET 266 is coupled to the drain terminal of an n-channel MOSFET 262. The gate and drain terminals of the MOSFET 270 are coupled together, and the gate and drain terminals of the MOSFET 262 are coupled together. The source terminal of the MOSFET 270 is coupled to the input terminal 206 that receives the V_{IN} input voltage; and the source terminal of the MOSFET 262 is coupled to a voltage supply rail 252, which is associated with a supply voltage (called “V_{SS}” in FIG. 5). In accordance with some embodiments, the V_{SS} supply voltage may be ground or circuit ground potential.

The gate and drain terminals of the MOSFET 270 are coupled to the gate terminal of a p-channel MOSFET 272. The source terminal of the MOSFET 272 is coupled to the input terminal 206, and the drain terminal of the MOSFET 272 is coupled to the control terminal 211. The gate and drain terminals of the MOSFET 262 are coupled to the gate terminal of an n-channel MOSFET 264. The source terminal of the MOSFET 264 is coupled to the supply voltage rail 252, and the drain terminal of the MOSFET 264 is coupled to the drain terminal of the MOSFET 272 and thus, is also coupled to the control terminal 211.

Due to the above-described architecture of the charge/discharge circuit 260, relatively fast charge and discharge paths are created for purposes of charging and discharging the capacitor 220 to counter the transients that are introduced by a rapidly changing load. More specifically, the MOSFETs 270 and 272 form a current mirror to charge the capacitor 220 and provide current (via the feedback current communication line 251) to the output terminal 194a to counter a decrease in the V_{OUT} output voltage. The MOSFETs 262 and 264 form a current mirror for purposes of discharging the capacitor 220 and sinking a current (via the feedback current communication line 251) from the output terminal 194a to counter an increase in the V_{OUT} output voltage.

It is noted that the charge/discharge circuit 260 may have a variety of different designs, depending on the particular embodiment. For example, in accordance with other embodiments, a cascade device may be disposed between the drain terminal of each MOSFET 264 and 272 and the control terminal 211. Furthermore, in other embodiments, bipolar transistors, or transistors based on other semiconductors or materials may be used, as persons of ordinary skill in the art understand. Thus, many variations are contemplated, which are within the scope of the appended claims.

As depicted in FIG. 5, in accordance with some embodiments, the pass device 210 may include two n-channel MOSFETs 276 and 278, whose drain terminals are coupled together. These drain terminals, in turn, are coupled to the V_{IN} input terminal 206. More specifically, in accordance with some embodiments, the source-to-drain path of a biasing p-channel MOSFET 280 is coupled between the drain terminal of the MOSFET 276, 278 and the V_{IN} input terminal 206. In this manner, the source terminal of the MOSFET 280 may be coupled to the input terminal 206, and the drain terminal of the MOSFET 280 is coupled to the drain terminals of the MOSFETs 276 and 278. The gate terminals of the MOSFETs 276 and 278 are coupled to the control terminal 211. Moreover, the source terminal of the MOSFET 278 is coupled to the output terminal 194a. A trimmable (or adjustable) resistor 290 is coupled between the output terminal 194a and the supply voltage rail 252 for purposes of providing a minimum load resistance (and minimum load current) on the output terminal 194.

In general, the source terminals of the MOSFETs 276 and 278 are coupled to the supply voltage rail 252. As shown in FIG. 5, in accordance with some embodiments, trimmable (or adjustable) resistances 280, 282, 284 and 286 may be used for purposes of setting the desired ratio between the V_{OUT} and V_{REF} voltages. In general, the resistor 280 is coupled between the source terminal of the MOSFET 276 and a node 283; the resistor 282 is coupled between source terminal of the MOSFET 278 and the node 283; the resistor 284 is coupled between the node 283 and the node 285; and the resistor 286 is coupled between node 285 and the supply voltage rail 252. In general, the relationship of the V_{OUT} and V_{REF} voltages may be described as follows:

$$\frac{{V}_{OUT}}{{V}_{REF}} = 1 + \frac{{R}_{3}}{{R}_{4}} + \frac{{R}_{1} {R}_{2}}{( {R}_{1} + {R}_{2} ) {R}_{4}} - \frac{{R}_{2}}{{R}_{1} + {R}_{2}} \frac{Δ V}{{V}_{REF}} , \qquad Eq . 1$$

where “R₁,” “R₂,” “R₃,” and “R₄” represent the resistances of the resistors 280, 282, 284 and 286, respectively; and “ΔV” represents the voltage between the source terminals 276 and 278.

Among its other features, in accordance with some embodiments, a capacitor 288 may be coupled between the node 285 and the output terminal 194a for purposes of imparting the appropriate frequency characteristics to the feedback path 214 to stabilize the linear regulator 200. Moreover, as depicted in FIG. 5, in accordance with some embodiments, the feedback path 214 may be formed from the resistors 280, 282, 284, 286 and 290. In this manner, the non-inverting input terminal of the amplifier 204 may be coupled to the node 285, in accordance with some embodiments.

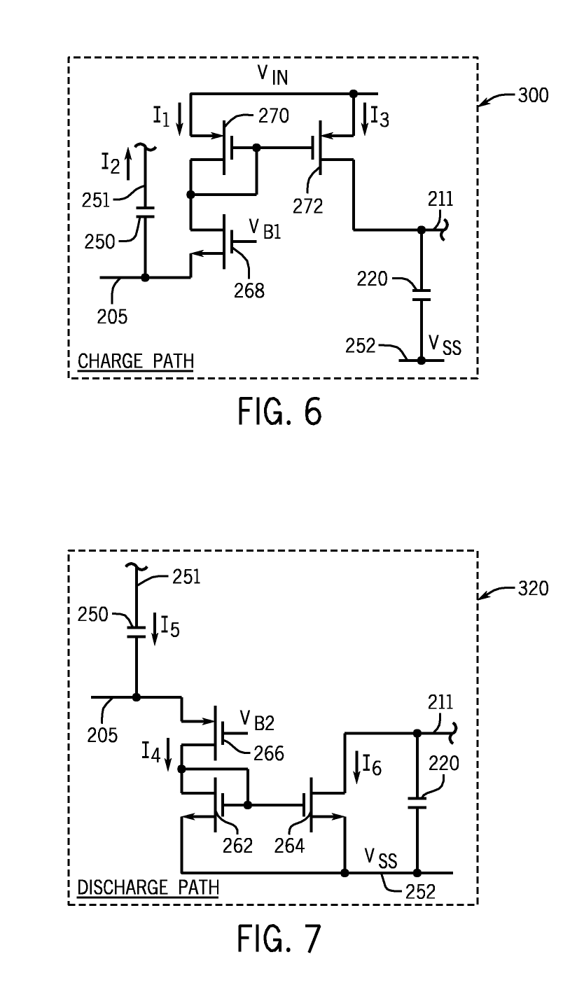

Referring to FIG. 6, in accordance with some embodiments, the charge/discharge circuit 260 (see FIG. 5) may use a charge path 300 for purposes of countering a decrease in the V_{OUT} output voltage. In this manner, a decrease in the V_{OUT} output voltage causes an I₂ current to be sourced to the output terminal 194a through the feedback current communication line 251, which produces a current I₁ that is communicated through the source-to-drain path of the MOSFET 270 and the drain-to-source path of the MOSFET 268. Due to the current mirror created by the MOSFETs 270 and 272, a mirrored I₃ current (i.e., a scaled version of the I₁ current, where the scaling is set by the channel width-to-channel length ratios of the MOSFETs 270 and 272) is communicated through the source-to-drain path of the MOSFET 272 to charge the capacitor 220. Thus, for charging purposes, the charge/discharge circuit 260 uses a current source to source the I₃ current to the capacitor 220 for purposes of charging the capacitor 220.

Referring to FIG. 7, in accordance with some embodiments, the charge/discharge circuit 260 (see FIG. 5) may use a discharge path 320 for purposes of countering an increase in the V_{OUT} output voltage. In this manner, an increase in the V_{OUT} output voltage causes a corresponding I₅ current from the output node 194a, which produces an I₄ current that is communicated through the source-to-drain path of the MOSFET 266 and the drain-to-source path of the MOSFET 262. Due to the current mirror formed by the MOSFETs 262 and 264, a mirrored I₆ current is created in the drain-to-source path of the MOSFET 264 to discharge the capacitor 220. Thus, for discharging purposes, the charge/discharge circuit 260 uses a current source to sink the I₆ current to discharge the capacitor 220.

While a limited number of embodiments have been disclosed herein, those skilled in the art, having the benefit of this disclosure, will appreciate numerous modifications and variations therefrom. It is intended that the appended claims cover all such modifications and variations.

What is claimed is:

1. A method comprising:
using a pass device of a linear regulator to provide an output signal for the linear regulator in response to a signal received at a control terminal of the pass device, the control terminal being coupled to a node and the node being associated with a bias current; and
using a feedback path to communicate a feedback current with the node to regulate the output signal, the using comprising regulating a magnitude of the feedback current to be within a range of magnitudes comprising a magnitude that exceeds a magnitude of the bias current.

2. The method of claim 1, further comprising:
using the feedback current to selectively charge and discharge a capacitance associated with the node.

3. The method of claim 2, wherein the pass device comprises a transistor, and the using the feedback path comprises using the feedback current to selectively charge and discharge an input capacitance of the transistor.

4. The method of claim 1, wherein the using feedback path to communicate the feedback current comprises using a capacitor coupled between an output terminal of the linear regulator and the node.

5. The method of claim 1, wherein the using the feedback path to communicate the feedback current comprises selectively using a first circuit to charge a capacitance associated with the node and selectively using a second circuit to discharge the capacitance.

6. The method of claim 1, wherein the using the feedback path to communicate the feedback current comprises selectively using a first current source to charge a capacitance associated with the node and selectively using a second current source to discharge the capacitance.

7. The method of claim 6, wherein the selectively using the first current source comprises selectively using a first current path to charge the capacitance, and the selectively using the second current source comprises selectively using a second current path other than the first current path to discharge the capacitance.

8. A regulator comprising:
a pass device comprising a control terminal and adapted to provide an output signal for the regulator in response to a signal received at the control terminal, the control terminal being coupled to a node and the node being associated with a bias current; and
a feedback path to communicate a feedback current with the node to regulate the output signal, the feedback path adapted to regulate a magnitude of the feedback current within a range of magnitudes comprising a magnitude that exceeds a magnitude of the bias current.

9. The regulator of claim 8, wherein the feedback path is adapted to selectively charge and discharge a capacitance associated with the node.

10. The regulator of claim 8, wherein the pass device comprises a transistor comprising an input capacitance, and the feedback path is adapted to selectively charge and discharge the input capacitance.

11. The regulator of claim 8, wherein the regulator further comprises an output terminal to provide the output signal and feedback path comprises a capacitor coupled between the output terminal and the node.

12. The regulator of claim 8, wherein the feedback path comprises a first current mirror to charge a capacitance associated with the node and a second current mirror to discharge the capacitance.

13. The regulator of claim 8, further comprising an amplifier to provide a control signal to the control terminal in response to a difference between a signal indicative of the output signal and a reference signal.

14. The regulator of claim 13, further comprising:
another feedback path to couple the output signal to the amplifier.

15. An apparatus comprising:
an integrated circuit comprising a regulator, the regulator comprising an amplifier, a pass device, a first feedback path and a second feedback path;
wherein
an output terminal of the amplifier is coupled to a control terminal of the pass device,
the pass device comprises an output terminal that provides an output signal for the regulator in response to a signal received at the control terminal of the pass device; and
the amplifier is adapted to regulate the signal received at the control terminal of the pass device in response to a signal provided by the first feedback path; and
the second feedback path is adapted to communicate a feedback current between the output terminal of the pass device and the output terminal of the amplifier node to regulate the output signal.

16. The apparatus of claim 15, wherein the second feedback path is adapted to selectively charge and discharge a capacitance associated with the control terminal.

17. The apparatus of claim 15, wherein the pass device comprises a metal oxide semiconductor field-effect-transistor (MOSFET) comprising a gate capacitance, and the second feedback path is adapted to selectively charge and discharge the gate capacitance in response to the output signal.

18. The apparatus of claim 15, wherein the second feedback path comprises a first current source adapted to selectively charge a capacitance associated with the node and a second current source adapted to selectively discharge the capacitance.

19. The apparatus of claim 15, wherein the amplifier is adapted to regulate the signal received by the control terminal in response to a difference between a signal indicative of the output signal and a reference signal.

20. The apparatus of claim 15, wherein the second feedback path comprises a capacitor coupled between an output terminal of the regulator and the control terminal.
